(19) United States
(12) Patent Application Publication
(10) Pub. No.: US 2008/0224561 A1
(43) Pub. Date: Sep. 18, 2008

(54) Electric motor, method for manufacturing electric motor, electromagnetic coil for electric motor, electronic device, and fuel cell equipped apparatus

(75) Inventor: Kesatoshi Takeuchi, Shiojiri (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/897,625

(22) Filed: Aug. 31, 2007

(30) Foreign Application Priority Data
Sep. 4, 2006 (JP) 2006-239595
Aug. 24, 2007 (JP) 2007-218899

(51) Int. Cl. H02K 3/32; H02K 15/10

(52) U.S. Cl. 310/194; 29/596; 29/602.1

(57) ABSTRACT

An electric motor having an electromagnetic coil, wherein the electromagnetic coil has wiring formed by a vapor deposited insulating layer wound on the entire exterior circumference of a conductive substrate.

### BACKGROUND

1. Technical Field

The present invention relates to an electric motor, method for manufacturing an electric motor, and a electromagnetic coil for an electric motor.

2. Related Art

There are two types of electric motor: synchronous motors and induction motors. Moreover, motor types can also be classified by differences in the rotor as magnet type that uses a permanent magnet, wound type that has a wound coil, and reactance type that uses a strong magnetic body such as iron. The magnet type rotates the permanent magnet of the rotor which is drawn to the rotating magnetic field of the stator.

The compact synchronous motor disclosed in JP-A-8-51745 below is an example of a magnet type synchronous motor. This compact synchronous motor is provided with a stator core wound with an exciting coil, and a rotor that incorporates a magnet.

JP-A-7-213027 below disclosed art concerning a method for forming a coil in which a plated pattern corresponding to a coil pattern is etched on a substrate 1, a coil conductor layer is deposited by an electrolytic plating method, and thereafter an interlayer insulating film is formed by resin application.

In regard to electric motors, it is important that electric motors are designed for compactness while maintaining drive performance. Electromagnetic coil drive performance has a particularly large influence on motor characteristics and electric motor compactness due to the conditions of the number of coil windings and resistance value.

In electromagnetic coils of the related art, however, there is a limit to the thin layering of the insulating layer since a heat resistant poly resin (for example, polyurethane, polyester, polyamidoimide and the like) is used as the insulating material of the conductor.

Therefore, winding efficiency is reduced by the limitation of the number of coil windings imposed by the thickness of the insulating layer. Furthermore, since the poly resins used as the insulating layer material have poor thermal conductivity, a problem arises insofar as the thermal conductivity of the conductor (for example, a copper substrate) is reduced. Heat dissipation is particularly poor in coils with multiple windings, thus further decreasing thermal efficiency.

Thermostability is therefore further reduced in the poly resin insulating layer material, which softens at approximately 220° C. Insulating effectiveness is thus reduced when the temperature in the vicinity of the conductor rises to approximately 220° C. due to the reduction in thermal efficiency. The insulating layer is easily damaged by increased mechanical stress between conductors (between coils), particularly in coils with multiple windings. Furthermore, there is concern of breaking wires by the temperature rise in the conductor itself.

Electric motors also require a high drive performance when starting. Therefore, a large drive current is supplied to the electromagnetic coil when starting, which causes a rapid temperature rise due to current induced copper loss affecting electric motor characteristics. When the drive current is excessively large, performance loss occurs in the electromagnetic coil itself due to failure of the insulating layer and disconnection of conductors. From the perspective of safety, therefore, the drive current must be set low. In a coil of the related art, the drive current must unavoidably be low, thus ultimately making it difficult to reduce the size of the motor itself while maintaining drive performance

### SUMMARY

An advantage of some aspects of the present invention is to eliminate the previously mentioned problems by providing an electromagnetic coil with excellent heat dissipating characteristics while capable of utilizing a thin layer. Further advantages are to provide a high performance electric motor, and a method for manufacturing same.

1 The electric motor of the present invention is an electric motor with an electromagnetic coil, and the electromagnetic coil has wiring formed by a vapor deposited insulating layer wound on the entire external circumference of a conductor substrate.

According to this configuration, a thin insulating layer film can be formed on the exterior circumference of a conductor substrate, and the number of windings of the electromagnetic coil can be increased. Furthermore, heat dissipating characteristics of the insulating layer can be improved. Therefore, the drive capacity of the electric motor is improved, and the device can be rendered more compact.

The vapor deposited insulating layer is formed by vapor-depositing the insulating layer on the conductor substrate. According to this configuration, a thin film insulating layer can be formed using the spattering method.

It is desirable that the vapor deposited insulating layer is formed by spattering an insulating layer on the conductor substrate. According to this configuration, a thin film insulating layer can be easily formed using the spattering method.

It is desirable that the vapor deposited insulating layer is formed of an oxide or nitride. According to this configuration, thermal conductivity of the insulating layer is improved.

2 The method for manufacturing the electric motor of the present invention is a method for manufacturing an electric motor having an electromagnetic coil, and includes a step of forming an insulating layer on the entire exterior circumference of a conductor substrate by evaporation vapor deposition or spattering, and a step of producing windings on the conductor substrate.

According to this method, a thin film insulating layer can be formed on the exterior circumference of the conductor substrate, and the number of windings of the electromagnetic coil can be increased. Furthermore, heat dissipating characteristics of the insulating layer can be improved. Therefore, the drive capability of the electric motor is improved, and the device can be rendered more compact.

It is desirable that the formation of the insulating layer is accomplished after producing the windings on the conductor substrate. According to this method, the electromagnetic coil is easily formed. It is desirable that the insulating layer is an oxide or nitride. According to this method, the thermal conductivity of the insulating layer is improved.

For example, there may be a step in which the insulating layer is formed by masking bilateral ends of the conductor substrate, and the bilateral ends of the conductor substrate are connected to other terminals. According to this method, the insulating layer is not formed in the masked areas, such that the conductor substrate is easily connected using these locations.

3 The electromagnetic coil for the electric motor of the present invention has wiring formed by a vapor deposited insulating layer wound on the entire exterior circumference of the conductor substrate. According to this configuration, a thin film insulating layer can be formed on the exterior circumference of the conductor member, such that the number of windings of the electromagnetic coil can be increased. Furthermore, the heat dissipating characteristics of the insulating layer are improved. Therefore, the drive capability of the electric motor is improved, and the device can be rendered more compact.

4 The electronic device of the present invention has the electric motor (for example, a single-phase brushless motor) according to any one of Claim 1, and a driven member driven by the single-phase brushless motor.

For example, the electronic device is a projector.

5 The fuel cell equipped apparatus of the present invention has a driven member driven by the electric motor (for example, a single-phase brushless motor), and a fuel cell for supplying power to the single-phase rushless motor.

### BRIEF DESCRIPTION OF THE DRAWINGS

FIG. 1 is a top view and cross section view of an embodiment of the electromagnetic coil;

FIG. 2 is a top view and cross section view of another embodiment of the electromagnetic coil;

FIG. 3 is a cross section view of the manufacturing process of the embodiment of the electromagnetic coil;

FIG. 4 is a cross section view of another manufacturing process of the embodiment of the electromagnetic coil;

FIG. 5 illustrate the condition of a masked embodiment of the electromagnetic coil;

FIG. 6 is a schematic view of the magnetic body configuration of the electric motor of the present invention and the operating principle thereof;

FIG. 7 shows the operating principle in continuation of FIG. 6;

FIG. 8 is a equivalent circuit diagram showing a plurality of coils connected in series, and an equivalent circuit diagram showing a plurality of coils connected in parallel;

FIG. 9 is a block diagram of the drive circuit that supplies excitation signals to the coils;

FIG. 10 is an exploded perspective view of an electric motor;

FIG. 11 shows the configuration of an electric motor;

FIG. 12 shows another configuration of an electric motor;

FIG. 13 shows the projector utilizing a motor according to the present invention; and

FIG. 14 shows the mobile phone utilizing a motor according to the present invention.

### DESCRIPTION OF EXEMPLARY EMBODIMENTS

The embodiments of the present invention are described hereinafter with reference to the drawings. Parts having the same function are identified with identical or similar reference numbers, and repeated description of such parts is omitted.

Electromagnetic Coil Structure

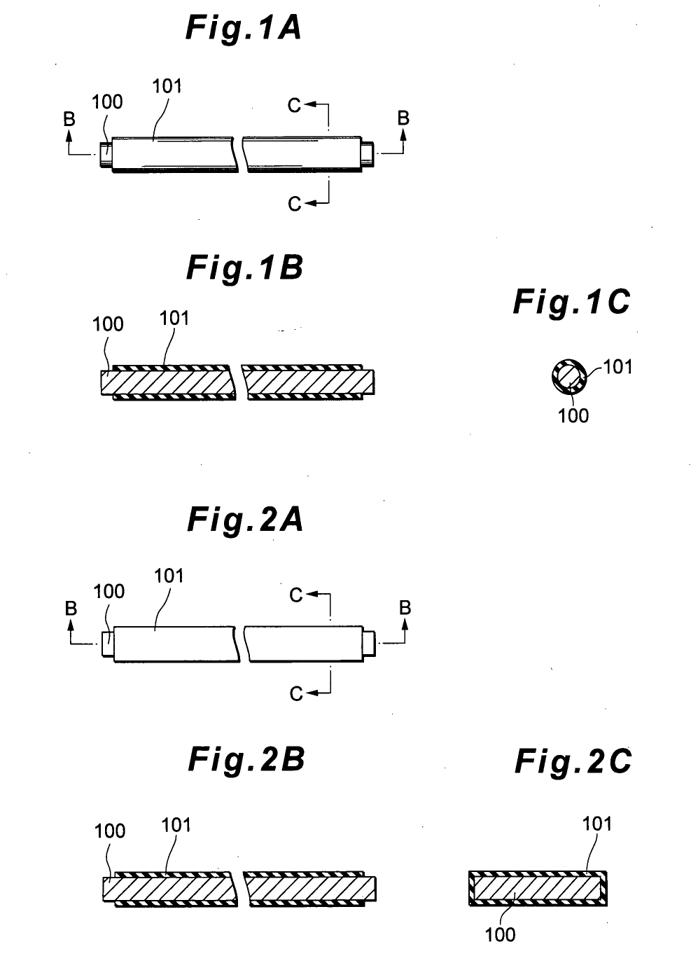

FIG. 1 is a front view and cross section views of and embodiment of the electromagnetic (exciting) coil. FIG. 1A is a top view. FIG. 1B and FIG. 1C are cross section views, corresponding to the cross B-B cross section and C-C cross section of FIG. 1A (FIG. 2 is similar). As shown in FIG. 1, an insulating layer (thin film insulating layer) 101 is formed around the circumference of a substrate layer 100 composed of metal, such as, for example, copper or the like. Although the cross section of the substrate layer 100 has an approximate circular shape in FIG. 1, the cross section of the substrate layer 100 may also be an approximate rectangular shape, as shown in FIG. 2. FIG. 2 is a top view and cross section views of another electromagnetic coil of the present embodiment. Furthermore, the cross section of the substrate layer 100 may also have an approximate ovoid (elliptic) configuration.

The insulating layer 101 is an insulating layer formed by vapor deposition. Vapor deposition includes PVD (physical vapor deposition) methods typified by spattering and evaporation. Silicon oxide (SiO₂) film, silicon nitride (Si₃N₄) film and the like may be used as material for the insulating layer 101. The method of forming the insulating layer 101 is described in detail below.

Since the insulating layer of the electromagnetic coil is formed by vapor deposition in the present embodiment, a thin film insulating layer can therefore be obtained. Thus, the number of windings can be increased with the result that winding efficiency can be improved and the drive capability of the electromagnetic coil is increased. Furthermore, the drive capability of an electric motor using this electromagnetic coil is increased. The electromagnetic coil can be made thinner (more compact) by reducing the coil thickness while having the same number of windings. Thus, an electric motor using this electromagnetic coil can be rendered more compact.

Moreover, the heat dissipating effect is improved by making a thinner insulating layer. Silicon oxide layers and silicon nitride layer in particular have high thermal conductivity, thus further improving heat dissipating efficiency when such materials are used. Nitride layers are more advantageous than oxide layers due to the greater thermal conductivity. Such layers are therefore resistant to even large drive currents due to the improved heat dissipating efficiency. The limiting value (maximum value) of the drive current is thus increased, and the drive capability is improved for an electric motor using this electromagnetic coil. The configuration of the electric motor using this electromagnetic coil is described in detail below.

Method 1 for Manufacturing Electromagnetic Coil

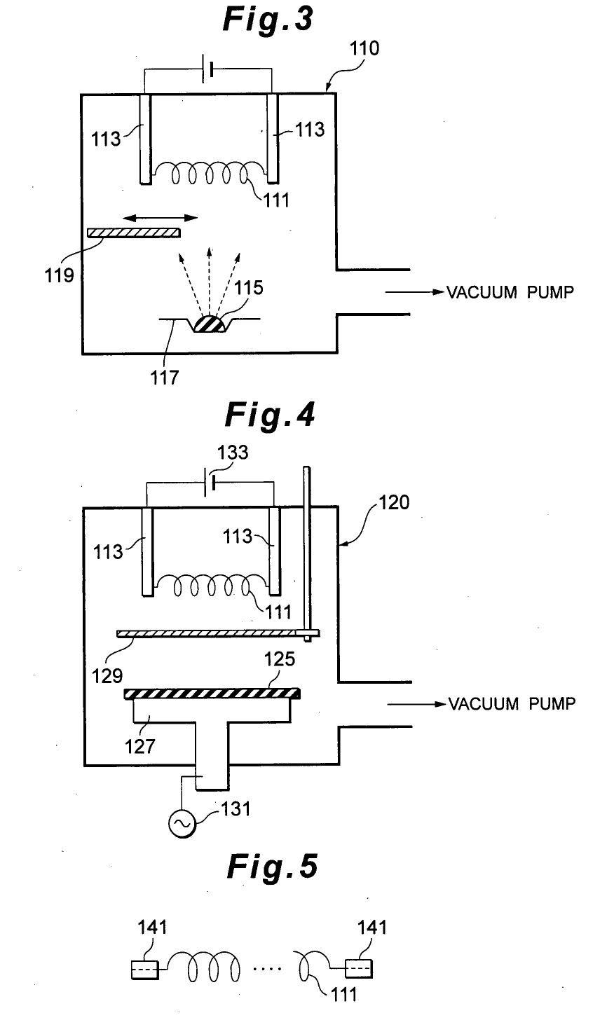

A method for manufacturing the above mentioned electromagnetic coil is described below. FIG. 3 is a cross section view showing the manufacturing process of the electromagnetic coil of the present embodiment.

As shown in FIG. 3, a conductive substrate 111 is placed in the chamber of a vacuum deposition device 110. The inside of the chamber is maintained in a vacuum state by a vacuum pump. In this case, the conductive substrate 111 is formed of, for example, copper, provided with a spiraled finish (windings). The bilateral ends of the conductive substrate 111 are supported, for example, by support members 113. An evaporation vapor deposition material (evaporation vapor deposition source) 115 is placed on a depression on a stage 117, this deposition material is heated by an electric potential applied by a power source not shown in the figure, and the vapor therefrom (deposition material) is dispersed within the chamber. The vapor deposition material may be, for example, silicon oxide, such that a silicon oxide layer of vapor deposition material adheres to the exterior circumference of the conductive substrate 111. A slide type shutter 119 is disposed between the vapor deposition material and the conductive substrate 111, such that the start and end of deposition are controllable by moving the shutter 119. A suitable electric potential may also be applied to the conductive substrate 111 through the support members 113.

An insulating layer can therefore be easily formed on the circumference of the conductive substrate 111 using the vapor deposition method. The thickness of the insulating layer is controllable on the order of several nanometers. Furthermore, using the vapor deposition method, an insulating layer can be precisely formed on the exterior circumference of the conductive substrate 111 which has been previously provided with a spiraled finish.

Method 2 for Manufacturing Electromagnetic Coil

Although the insulating layer was formed by vapor deposition in manufacturing method 1 (FIG. 3), the insulating layer may also be formed using the spattering method. FIG. 4 is a cross section view showing another process for manufacturing the electromagnet coil of the present embodiment.

As shown in FIG. 4, the conductive substrate 111 is placed in the chamber of a spattering device 120. A suitable inert gas (for example, argon) is introduced into the chamber and a vacuum state is maintained by a vacuum pump. In this case, the conductive substrate 111 is formed of, for example, copper, and provided with a spiraled finish. The bilateral ends of the conductive substrate 111 are supported by, for example, support members 113. A target (for example, silicon oxide mass) 125 is placed on the stage 127, and a high frequency power source 131 is applied. The atoms (for example, argon) within the chamber collide with the target when such a high frequency voltage is applied within the chamber, and the expelled target particles (in this case, silicon oxide) form a layer. Thus, a silicon oxide layer is formed on the exterior circumference of the conductive substrate 111. A rotary type shutter 129 is provided between the conductive substrate 111 and the spattering material (target), such that the start and end of spattering is controllable by moving the shutter 129. In the spattering method, the constituents of the formed layer are mostly deposited on the target side. Layer formation can also be performed on the part of the conductive substrate 111 on the opposite side from the target side by, for example, attracting the target particles thereto by the application of an electric potential 133 to the conductive substrate 111 through the support members 113.

Although a layer was formed on a conductive substrate 111 which was previously provided with a spiraled finish in FIGS. 3 and 4, layer formation (vapor deposition, spattering layer formation) may also be performed on an approximately rectilinear conductive substrate 111. Since the layer forming constituents are deposited mostly on the target side in spattering layer formation in particular, the uniformity of the insulating layer can be improved by forming the layer while suitably rotating the approximately rectilinear shaped conductive substrate 111. In this case, the electromagnet coil is formed by providing a spiraled finish on the conductive substrate (wiring) 111 after the insulating layer has been formed.

Although the target is a silicon oxide layer in FIG. 4, layer formation may also be accomplished using silicon as the target while introducing oxygen into the chamber. That is, the silicon oxide layer may be formed by depositing the expelled target particles (Si) as the particles are oxided. In this case, the conductive surface is oxided. The surface etching speed of the pattering particles and the deposition speed of the silicon oxide can be adjusted by adjusting the voltage within the chamber, such that the silicon oxide layer can be precisely formed on the surface of the conductive substrate.

Furthermore, the silicon oxide layer may be formed by spattering after an antioxidant layer has been previously formed on the surface of the conductive substrate. In this case, the antioxidant layer may also be formed using the spattering method.

Although silicon oxide is used as the deposition material and target material in the layer formation methods 1 and 2 (FIGS. 3 and 4), silicon nitride may also be used. Other metal insulating layers may also be used. Moreover, a silicon nitride layer may be formed using silicon as the target in a nitrogen atmosphere. An oxide-nitride layer may also be formed.

In the layer forming methods 1 and 2 (FIGS. 3 and 4), the laminate layer thickness of the coil and insulating layer can be optimized by setting the adjacent coil distance (d) to the degree of being filled with insulating material.

Although the target and deposition material are placed at the bottom part of the device in the layer forming methods 1 and 2 (FIGS. 3 and 4), the target and deposition material may also be placed in the top part of the device. In this case, a stage is placed in the bottom part of the device, and the conductive substrate 111 is disposed on the stage when forming the layer. It is desirable in this case that the conductive substrate is suitably rotated during layer formation since the layer can not be formed on the surface that is in contact with the stage.

Since both ends of the conductive substrate 111 are covered by the support members 113 in the above layer forming methods (FIGS. 3 and 4), layer formation can not be performed on these parts. Therefore, these parts can easily be used as contacts for external terminals. As shown in FIG. 5, the bilateral ends of the conductive substrate 111 may also be masked beforehand with tape or like material. Reference number 141 refers to a masking material. FIG. 5 illustrates the mask condition of the electromagnetic coil of the present invention. In this case, the conductive substrate 111 of the masked areas can be exposed by peeling away the tape, and these parts can be used to make contact with external terminals. Furthermore, if the mask material 141 is heat meltable, the mask material 141 can be easily removed by simply heating.

The support members 113 may also be disposed at another position, for example, at the side walls of the chamber, and the configuration of the support members 113 is not specifically limited. The method of support may also be a suspension method, clamping method or the like, and various methods may be used to render the conductive substrate stationary.

Application to Electric Motors

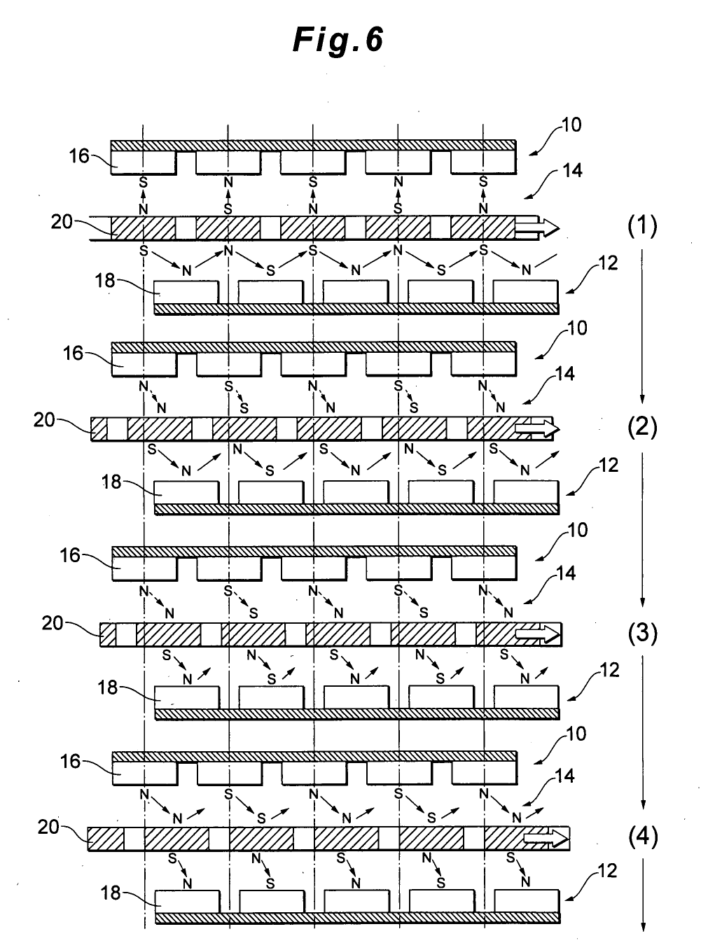

The configuration of an electric motor using the above electromagnetic coil (wiring) is described below with reference to FIGS. 6 to 11.

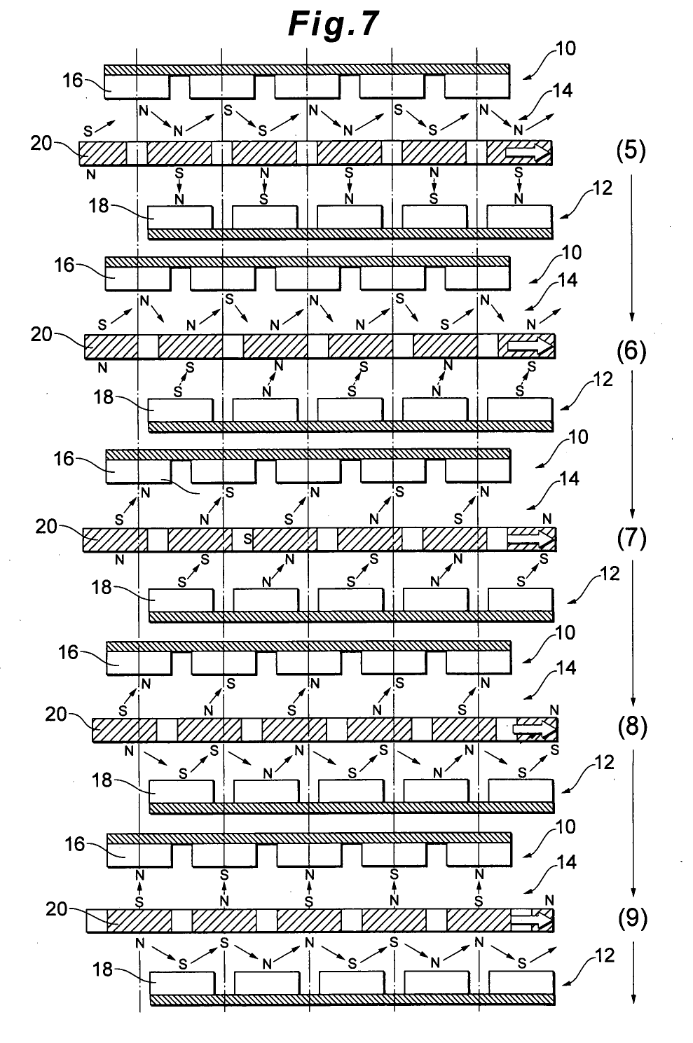

FIGS. 6 and 7 show the operating principle of the electric motor of the present invention. This motor is provided a structure in which a third permanent magnet 14 is interposed between a first coil assembly (coil assembly A) 10 and a second coil assembly (coil assembly B) 12. These coils and the permanent magnet may be configured either as a ring (circular arc, circle) configuration or linear configuration. When formed as a ring, either the permanent magnet or the coil assemblies function as a rotor; when formed in a linear configuration, either functions as a slider.

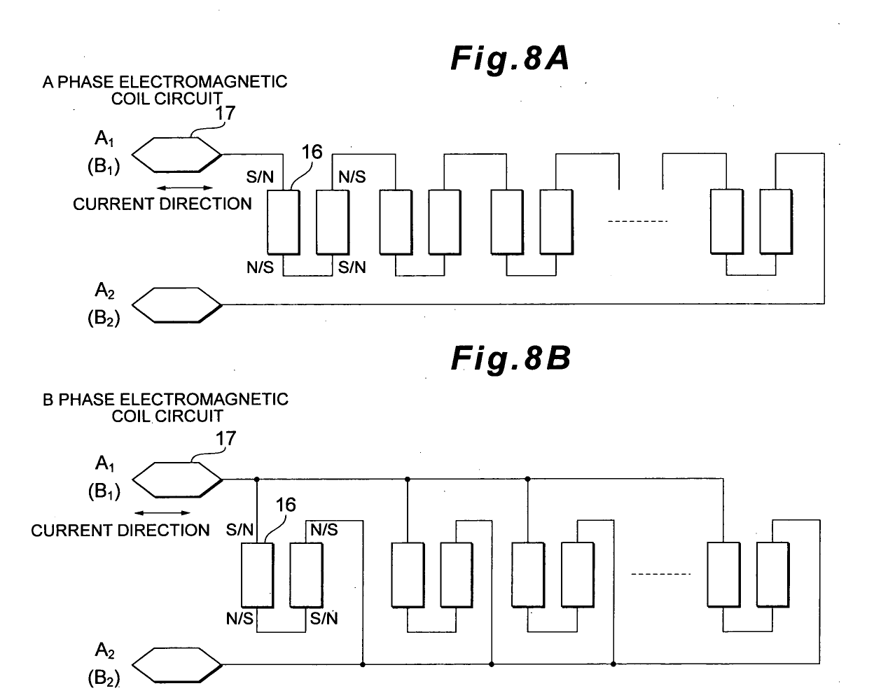

The first coil assembly 10 is provided with a configuration in which coils 16 that are alternatingly excitable by different poles are sequentially arranged at a predetermined spacing, and preferably at equal spacing. An equivalence circuit diagram of the first coil assembly 10 is shown in FIG. 8. According to FIGS. 6 and 7, all coils are alternately excited during the start of rotation (2π) of normal operation of a two-phase exciting coil, as described later. Accordingly, the driven units of the rotor and slider can rotate/drive at high torque.

As shown in FIG. 8(A), a plurality of exciting (electromagnet) coils 16 (excitation unit) alternately excited by different poles are connected in series at equal spacing. Reference number 18A is a block showing a drive circuit that applies a frequency pulse signal to this magnetic coil. Each coil is preset so as to be excited when excitation signals flow from this drive circuit to excite the coils in the electromagnetic coil 16 and alternately change the direction of the magnetic poles between adjacent coils. As shown in FIG. 8(B), the electromagnet coils 16 may also be connected in parallel. This coil configuration is similar to the A phase, B phase coils.

When signals that have a frequency to alternately switch the direction of the polarity of a supplied excitation current by a predetermined period are applied to the electromagnetic coil 16 from a drive circuit 17, a magnetic pattern of alternately changing polarity, N pole→S pole→N pole, on the side facing the rotor 14 is formed in the A phase coil assembly 10 as shown in FIG. 6 and FIG. 7. When the frequency signal reverses polarity, a magnetic pattern is generated in which the polarity of the first magnetic body on the third magnet body side alternately changes S pole→N pole→S pole. As a result, the excitation pattern manifest in the A phase coil assembly 10 changes periodically.

The configuration of the B phase coil assembly is identical to the A phase coil assembly; with the exception that the electromagnetic coil 18 of the B phase coil assembly is positionally shifted relative to the A phase coil assembly 16. That is, the array pitch of the B phase coil assembly and the coil array pitch in the A phase coil assembly are offset so as to have a predetermined pitch difference (angular difference). This pitch difference is the working angle of the permanent magnet 14 (one rotation) corresponding to one frequency period (2π) of the excitation current to the coils 16 and 18, for example, π/(2/M) where M is an ideal number of sets of permanent magnets (N+S). When M=2, for example, this working angle becomes π/4.

The permanent magnets are described below. As shown in FIGS. 6 and 7, the permanent magnet rotor 14 is disposed between two phase coil assemblies, and a plurality of permanent magnets 20 with alternatingly opposite polarities are arrayed in a line (circular arc configuration) at predetermined spacing, which is ideally equal spacing. The circular arc configuration includes completely circular, other closed loops such as ovals, unspecified ring-shaped configuration, semicircle, and fan shaped.

The A phase coil assembly 10 and the B phase coil assembly 12 are arranged at equal distance, and the third magnetic body 14 is disposed medially to the A phase coil assembly 10 and the B phase coil assembly 12. The array pitch of the permanent magnets of the permanent magnet 20 is approximately identical to the array pitch of the exciting coils in the A phase coil assembly lo and the B phase coil assembly 12.

. The operation of the magnetic body configuration, in which the previously mentioned third magnetic body 14 is disposed between the first magnetic body 10 and the second magnetic body 12, is described below using FIGS. 6 and 7. At a given moment, an excitation pattern such as that shown in FIG. 6(1) is generated in the electromagnetic coils 16 and 18 of the A phase coil and the B phase coil by the previously described drive circuit (17 in FIG. 8).

A magnetic polarity occurs at this time in the pattern of →S→N→S→N→S→ in each coil 16 of the surface facing the permanent magnet 14 side of the A phase coil 10, and a magnetic polarity occurs at this time in the pattern of →N→S→N→S→N→ in the coil 18 of the surface facing the permanent magnet 14 side of the B phase coil 12. The figure shows the electrical relationship between the permanent magnet and each phase coil, in which a repulsion force is generated between like poles, and an attraction force works between unlike poles.

At the next moment, when the pulse wave polarity applied to the A phase coil from the drive circuit 18 is reversed, as shown in (2), the permanent magnet 14 is sequentially moved in a rightward direction in the figures, as shown in FIG. 6(1) to FIG. 7(5), since a repulsion force is generated between the magnetic pole of the permanent magnet 20 and the magnetic pole generated in the coil 16 of the A phase coil 10 of (1), whereas an attraction force is generated between the magnetic pole of the surface of the permanent magnet 20 and the magnetic pole generated in the coil 18 of the B phase coil 12.

A pulse wave, which has a phase shifted from the excitation current of the A phase coil, is applied to the coil 18 of the B phase coil 12, such that the magnetic pole of the surface of the permanent magnet 20 and the magnetic pole of the coil 18 of the B phase coil 12 are repelled, and the permanent magnet 14 is moved further in a rightward direction, as shown in FIG. 7 (6) to (8). (1) to (8) show the situation when the rotor 14 has fixed rotation, and after (9) is similar with the remaining rotation. Thus the rotor is rotated by supplying a drive current (voltage) signal of a predetermined frequency and shifted phase to the A phase coil array and the B phase coil array.

When the A phase coil array, B phase coil array, and permanent magnet are configured in a circular arc, the magnetic structure shown in FIG. 6 configures a rotary motor; when the A phase coil array, B phase coil array, and permanent magnet are configured in a linear configuration, the magnetic structure configures a linear motor. With the exception of the case, permanent magnet of the rotor, and the electromagnetic coil, weight can be reduced by using resin nonmagnetic resin (including carbon) and ceramics, to realize a rotary drive body having an excellent power-to-weight ratio without generating iron loss by having an open condition magnetic circuit without using a yoke.

According to this configuration, the torque generated by the permanent magnet is increased because the permanent magnet can receive the magnetic force from the A phase coil and B phase coil, and a compact and light weight motor drivable at a high torque and having excellent torque-to-weight balance can therefore be provided.

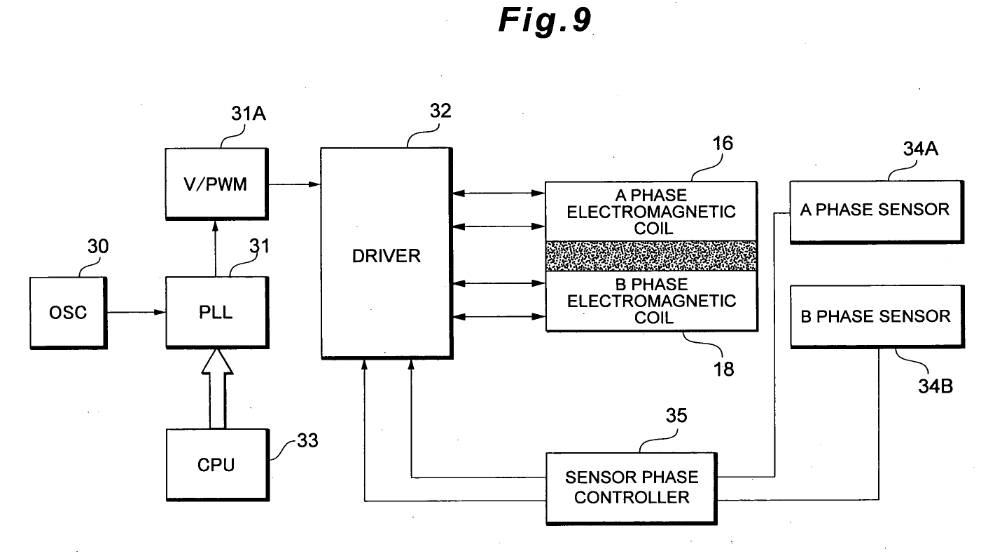

FIG. 9 is a block diagram showing an example of the drive circuit 17 for applying an excitation current to the electromagnetic coil 16 of the magnetic body of the A phase coil array and the electromagnetic coil 18 of the B phase coil array. The drive circuit 17 is configured so as to supply controlled pulse frequency signals to the A phase magnetic coil 16 and the B phase magnetic coil 18, respectively. Reference number 30 refers to a crystal oscillator (OSC), and reference number 31 refers to an M-PLL (phase synchronous, phase-locked loop) for generating a standard pulse signal by M-multirate division of the oscillation frequency signal of the OSC 30.

Reference number 34 refers to sensors that generate position detection signals corresponding to the rotation speed of the rotor, that is, the permanent magnet 14 (for example, Hall device sensors which detect a change in the magnetic field of the permanent magnet). Reference number 34A is an A phase sensor for supplying a detection signal to a driver circuit of the A phase electromagnetic coil, and reference number 34B refers to a B phase sensor for supplying a detection signal to a driver circuit of the B phase electromagnetic coil.

The respective detection signals from the sensors 34A and 34B are output to a driver to supply an excitation current to each phase coil array. Reference number 33 refers to a CPU (central processing unit), which outputs predetermined control signals to the M-PLL circuit 31 and the driver 32. The driver 32 is configured so as to supply the detection signals from the sensors to the electromagnetic coils either directly or with controlled PWM (pulse width modulation). Reference number 31A refers to a control unit for supplying a standard wave for PWM control to the driver. Although the magnetic sensor 34A of the A phase coil array and the magnetic sensor 34B of the B phase coil array respectively detect the magnetic field of the permanent magnets which are provided with a phase difference as previously noted, the detection signals may be phase controlled according to need prior to being supplied to the driver 32. Reference number 35 refers to a sensor phase controller.

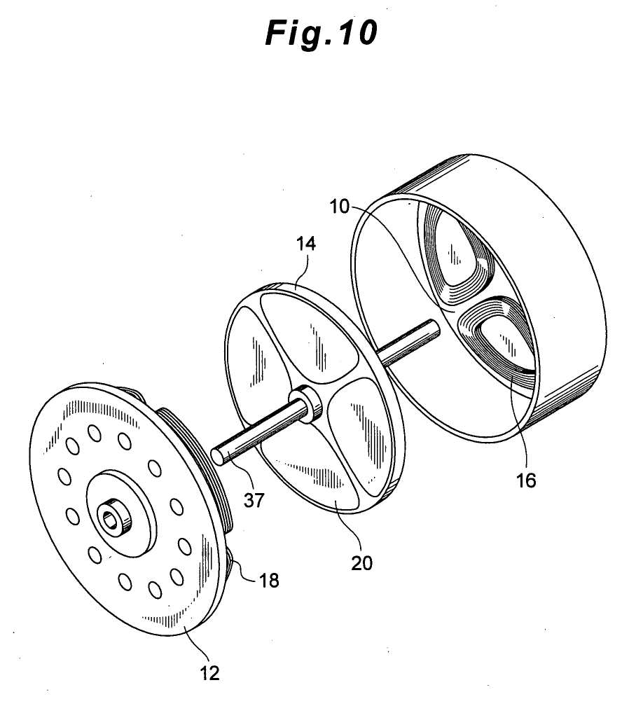

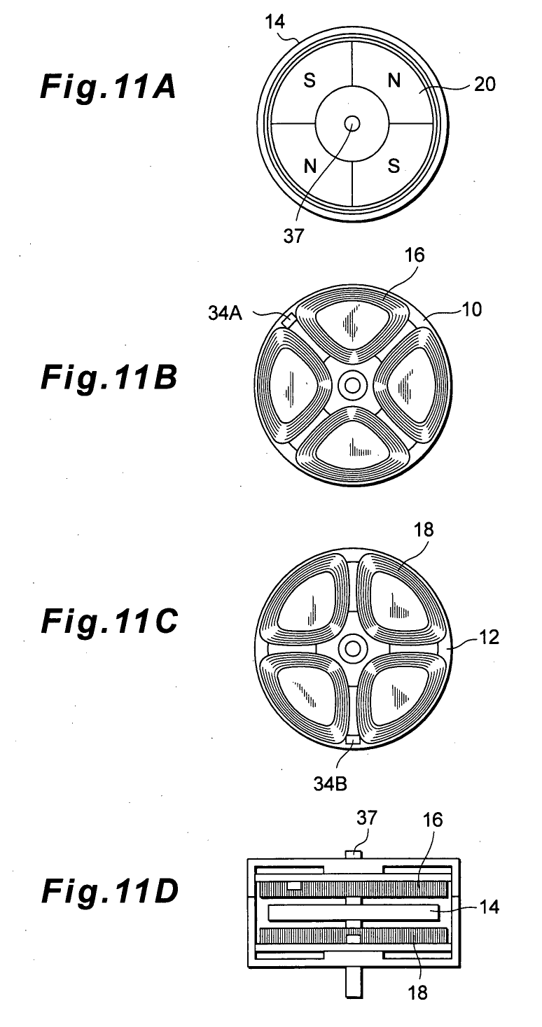

FIG. 10 is an exploded perspective view of the essential parts of the electric motor. FIG. 11 shows the structure and structural components of the electric motor; (A) through (C) are top views of the structural components, and (D) is a structural cross section view.

As shown in FIGS. 10 and 11, the motor is provided with paired A phase coil array 10 and B phase coil array 12 which are equivalent to a stator, the previously described permanent magnet 14 which configures a rotor, wherein the rotor 14 is arranged so as to be rotatable on a shaft 37 between the A phase coil array 10 and B phase coil array 12. The appended reference numbers are the same as the corresponding structural components in the previously mentioned drawing. The rotating shaft 37 is inserted in a hole for the rotating shaft formed in the center of the rotor, such that the rotor and rotating shaft rotate integratedly as a unit. As shown in the drawing, elements (S, N) of four permanent magnets 20 are provided at equal spacing in the circumferential direction of the rotor so that the polarities of the permanent magnet polar elements are alternatingly opposed; four electromagnetic coils are provided at equal spacing in the circumferential direction of the stator.

The A phase sensor 34A and the B phase sensor 34B are provided on the interior walls of the case of the A phase coil array with shifted phase (a distance equivalent to π/4). The A phase sensor 34A and B phase sensor 34B are alternately phase shifted in order to provide a predetermined phase difference between the frequency signal supplied to the A phase coil 16 and the frequency signal supplied to the B phase coil 18.

It is desirable that Hall devices that utilize the Hall effect are used as the sensors so as to be capable of detecting the position of the permanent magnet from the change in polarity that accompanies the movement of the permanent magnet. Using such sensors, the position of the permanent magnet is detectable by the Hall device wherever the permanent magnet may be when the interval from the S pole to the next S pole of the permanent magnet is set at 2π.

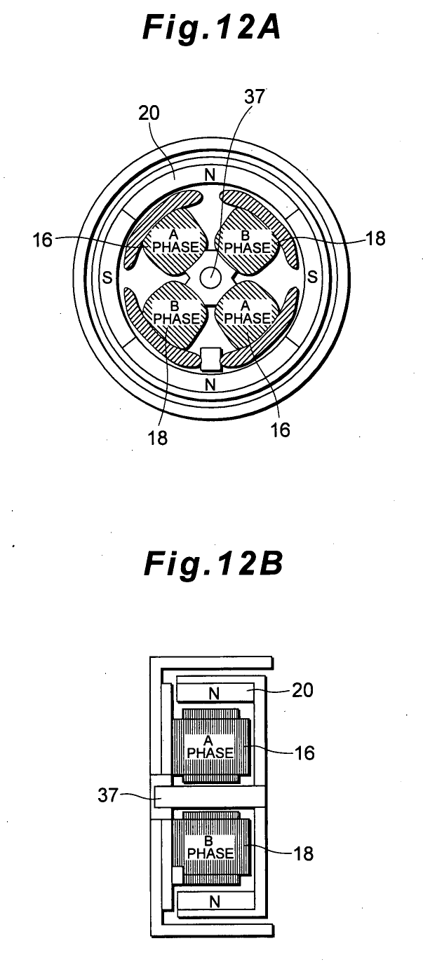

FIG. 12 shows another configuration of the electric motor. As shown in the figure, the permanent magnet 20 and a substrate on which the A phase coils 16 and B phased coils 18 are arranged may be disposed so as to face the rotor formed in the side wall. Specifically, the A phase coils 16 and the B phase coils 18 have an alternating arrangement on the substrate, and the permanent magnets 20 are arranged so as to circumscribe s the outer side of each coil. The permanent magnets 20 have alternating S pole and N pole.

As described in detail above, if the electromagnetic coil of the present invention is used in the A phase and B phase coils 16 and 18 in the electric motor described above, the drive capability of the electric motor can be increased and the motor can be rendered more compact since the electromagnetic coil drive capability is increased, and the electromagnetic coil can be rendered thinner (more compact).

Although the present embodiment has been described by way of examples using the electric motor shown in FIG. 10 and the like, electric motor may have other configurations, moreover the present invention is applicable to motors and devices of various kinds such as fan motors, clocks for driving the clock hands, drum type washing machines with single rotation, jet coasters, and vibrating motors. Where the present invention is implemented in a fan motor, the various advantages mentioned previously (improvement of drive capability of the electric motor, miniaturization of the electric motor) will be particularly notable. Such fan motors may be employed, for example, as fan motors for digital display devices, vehicle on-board devices, fuel cell equipped apparatuses such as fuel cell equipped mobile phones, projectors, and various other devices. The motor of the present invention may also be utilized as a motor for various types of household electric appliances and electronic devices. For example, a motor in accordance with the present invention may be employed as a spindle motor in an optical storage device, magnetic storage device, and polygon mirror drive.

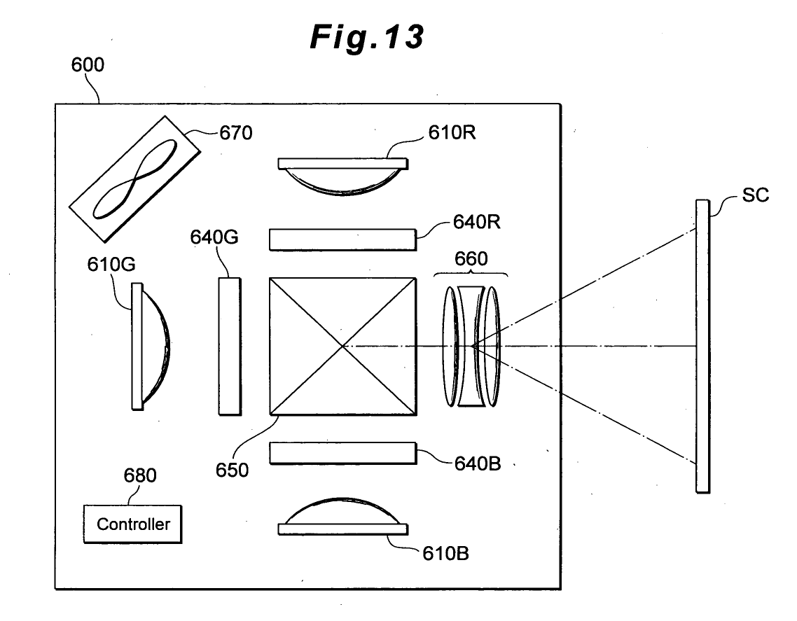

FIG. 13 illustrates a projector utilizing a motor according to the present invention. The projector 600 includes three light sources 610R, 610G, 610B for emitting three colored lights of red, green and blue, three liquid crystal light valves 640R, 640G, 640B for modulating the three colored lights, a cross dichroic prism 650 for combining the modulated three colored lights, a projection lens system 660 for projecting the combined colored light toward a screen SC, a cooling fan 670 for cooling the interior of the projector, and a controller 680 for controlling the overall projector 600. Various rotation type brushless motors described above can be used as the motor for driving the cooling fan 670.

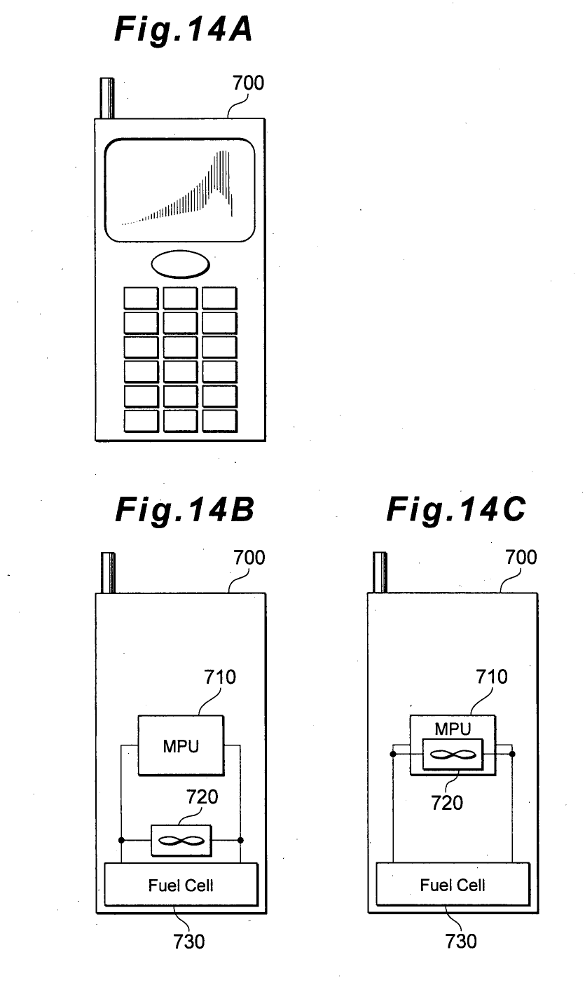

FIGS. 14A to 14C illustrate a mobile phone utilizing a motor according to the present invention. FIG. 14A shows the external view of a mobile phone 700, and FIG. 14B shows its exemplary internal configuration. The mobile phone 700 includes a MPU 710 for controlling the operation of the mobile phone 700, a fan 720, and a fuel cell 730. The fuel cell 730 supplies power to the MPU 710 and the fan 720. The fan 720 is installed mainly to exhaust the interior of the mobile phone of water which will be produced by the fuel cell 730. The fan 720 may be installed over the MPU 710, as illustrated in FIG. 14C, to cool the MPU 710. various rotation type brushless motors described above can be used as the motor for driving the fan 720.

The present invention is not limited to the embodiments described above inasmuch as the embodiments and examples described in the embodiments of the invention may be suitably combined, modified, or improved as necessary.

What is claimed is:

1. An electric motor having an electromagnetic coil, wherein
the electromagnetic coil has wiring formed by a vapor deposited insulating layer wound on the entire exterior circumference of a conductive substrate.

2. The electric motor according to claim 1, wherein the vapor deposited insulating layer is an insulating layer vapor-deposited on a conductive substrate.

3. The electric motor-according to claim 1, wherein the vapor deposited insulating layer is formed by spattering the insulating layer on the conductive substrate.

4. The electric motor according to claim 1, wherein the vapor deposited insulating layer is formed of an oxide or nitride.

5. A method for manufacturing an electric motor having an electromagnetic coil, the method comprising:
forming an insulating layer on the entire exterior circumference of a conductive substrate by evaporation vapor deposition or spattering; and
producing windings on the conductive substrate.

6. The method for manufacturing an electric motor according to claim 5, wherein the insulation layer is formed after producing windings on the conductive substrate.

7. The method for manufacturing an electric motor according to claim 5, wherein the insulating layer is formed of an oxide or nitride.

8. The method for manufacturing an electric motor according to claim 5, wherein the insulating layer is formed when bilateral ends of the conductive substrate are masked,
the method further comprising: connecting the bilateral ends of the conductive substrate to other terminals.

9. An electromagnetic coil for an electric motor, having wiring formed by a vapor deposited insulating layer wound on the entire exterior circumference of a conductive substrate.

10. An electronic device, comprising:
the electric motor according to any one of claim 1; and
a driven member driven by the single-phase brushless motor.

11. The electronic device according to claim 10, wherein the electronic device is a projector.

12. A fuel cell equipped apparatus, comprising:
the electric motor according to any one of claim 1
a driven member driven by the single-phase brushless motor; and
a fuel cell for supplying power to the single-phase brushless motor.
